(19) United States
(12) Patent Application Publication
(10) Pub. No.: US 2012/0316968 A1
(43) Pub. Date: Dec. 13, 2012

(54) CULINARY FOOD AND RELATED CULINARY PRODUCTS METHOD AND EDUCATIONAL TEACHING SYSTEM

(75) Inventor: EDWARD L. PATRICK, Anaheim, CA (US)

(73) Assignee: Estilo Hacienda, Inc.

(21) Appl. No.: 13/155,774

(22) Filed: Jun. 8, 2011

(51) Int. Cl. G06Q 30/02

(52) U.S. Cl. 705/14.66

(57) ABSTRACT

A method and educational teaching system to make interactive and customized culinary food and related culinary products demonstrations directly available to end users, including consumers and vendors. At the end user's convenience and choice of location the end user controls the interactive informational and educational demonstrations of culinary food and related culinary products via communication networks.

### 1. FIELD OF THE INVENTION

The present invention relates to an interactive and customized informational and educational teaching and demonstration system of culinary food and related culinary products via communication networks.

### 2. BACKGROUND OF THE INVENTION

Consumers are bombarded with an endless selection of culinary food and related culinary products. Nonetheless, the endless selection helps fulfill the needs of consumers. For the busy consumer, convenient meals have worked its way into his or her diet. For the adventurist consumer, exotic entrées challenge and intrigue his or her taste buds. For the conventional consumer, a home cook meal tops all other choices. And the list goes on. Thus, the differing desires, taste, lifestyles, etc. demand an endless selection of culinary food and related culinary products.

To cater to these demands, manufactures and merchants continuously develop a wide variety of culinary food and related culinary products, ranging from frozen foods to specialized gourmet feast. In addition, related culinary products expand the consumers' food and cooking experience. Unfortunately, the choices can also be overwhelming. In particular, consumers with an appetite for culinary meals are left shuffling through the voluminous choices before finding the perfect culinary food or related culinary product. The search for the right product will often be delayed when the culinary food and related culinary product lie hidden amongst the infinite choices.

Thus, manufacturers and merchants are perplexed at finding the most efficient ways to inform and teach consumers about the available culinary food and related culinary products. Similarly, consumers are hesitant to purchase new culinary food and related culinary products without more information, such as a live demonstration explaining and inspiriting the consumer, and presentation of the uses and recommendations of the culinary food and related culinary products.

Often manufacturers and merchants try to reach end users, consumers and vendors alike, directly by providing live educational demonstrations, for example, at local supermarkets or at the vendor's place of business. Even on the busiest day, these live educational demonstrations are limited to end users present at the particular location and who could spare his or her time to participate. In addition, these live educational demonstrations are costly without the guarantee of high informational and educational dissemination. Regardless, manufacturers and merchants continue to recognize the importance of product demonstrations.

It is from the combination of an effective culinary food and related culinary products demonstration made directly available an end user, customized to his or her demand, that the manufacture and merchant will fully inform and educate the end user. Also, through the use of communication networks, end users will have the options to choose the location, time and language to learn about the culinary food and related culinary products. This will expand the end user's ability to maximize his or her time and select to learn only about the desired recommendations and/or features of the culinary food and related culinary products.

Most importantly, through the use of communication networks end users can access the informational and teaching demonstrations globally. This will provide end users with the flexibility to learn about culinary food and related culinary products from the manufacturers and merchants without waiting for a live on-site demonstration. Rather the live demonstration is made available at the end user's fingertips.

### 3. DESCRIPTION OF RELATED ART

Cooking products, including gourmet foods, range from brand, flavor, quality, etc. For example, condiments are available in different sizes, colors, and dietary features. These variations cater to the captive audience that desired each creation. Products can come with different features, functions and uses. For example, a microwave can come in different colors, size, temperature settings, etc. With the available options two similar microwave from the same maker can variety in features, functions and uses. When the end users are presented with general information regarding a model product without the ability to customize the demonstration to the end user's product of choice, the end users may not be fully informed of all the features, functions and uses of a particular product.

Manufacturers and merchants must employ ways to bring each product's variation to the audience awaiting its arrival. Manufacturers and merchants of these products typically employ in-store demonstrations to reach potential consumers. When manufacturers and merchants present its products through demonstrations, the demonstration are limited by time, location and supplies. Manufacturers and merchants can only demonstrate the use of pre-selected products at any given location and time.

Manufacturers and merchants have also employed detailed literatures or basic video clips. These video clips can be incorporated with the product or made available through electronic media. The video demonstrations often comprise of general demonstrations regarding a model product without allowing the end user to view the entire catalog of products or the particular product the end user selected.

### 4. SUMMARY OF INVENTION

An embodiment of the present invention provides a method and educational teaching system for an interactive and customized culinary food and related culinary products demonstration. The method and educational teaching system provides end users with information regarding the interested culinary food and related culinary products, including an interactive and customized video demonstration. Depending on the preference of the end user regarding the ideal use of the culinary food and related culinary products, a suggested interactive video demonstration is made available to the end user. Providing the same benefits of a live demonstration, the end user can experience and learn directly from the manufacturers or merchants about the culinary food and related culinary products without installing any additional hardware.

The method and educational teaching system is made available to the public at large but allows each individual end user the ability to control the location and time of the demonstrations. The end user can provide the method and educational teaching system with the end user's information, preferences and requests. With the data provided the method and educational teaching system will suggest interactive options for the end user to customize the video demonstrations. To provide the end user more flexibility, the method and educational teaching system will store the data provided by the end user and reproduce the same suggested interactive options to the end user when the system recognizes that particular end user.

Each end user can participate in as many informational and educational demonstrations as the end user desires. Each method and educational teaching system is equipped with available interactive options for the end user to customize the video demonstration to reflect the end user's interests, select recipes, retrieve educational and informational facts and suggestions purchase the demonstrated products and ask the merchant or manufacturers questions.

### 5. BRIEF DESCRIPTION OF THE DRAWINGS

FIG. 1 Shows when end users can first be informed of the method and educational teaching methods through Hang Tags or electronic media.

FIG. 2 Shows how the end user can gain global access via communication networks through an execution code or electronic link.

FIG. 3 Shows the initial exchange between the end user and the server system.

FIG. 4 Shows the data collection and data retrieval process between the end user and the server system.

FIG. 5 Shows the process of the interactive information and educational system.

### 6. DETAILED DESCRIPTION OF THE INVENTION

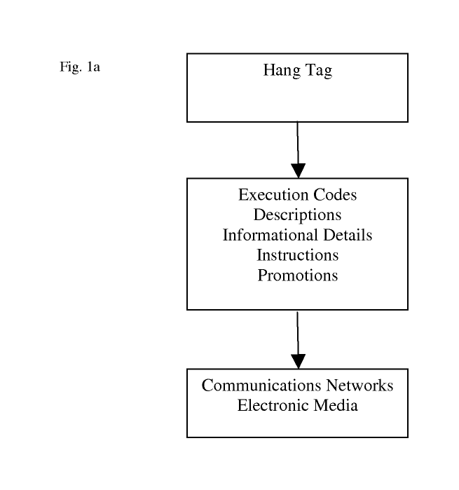

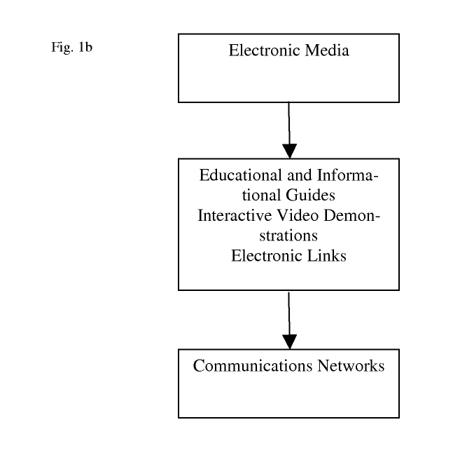

### FIG. 1

### FIG. 1a

Hang tags are conspicuously placed on the culinary food and related culinary products and made available to end users. The hang tags may be located on the culinary food and related culinary products or via advertisement, including printed or electronic advertisements. The hang tags provide brief informational details about the particular product allowing the end users to quickly access the functionality of the product or inquire more by following the instructions from the hang tag. The hang tags can also include the execution codes, descriptions of the product, informational details, instructions and promotions. The information provided can lead the end user to additional information and demonstrations from an available electronic media or communication networks.

### FIG. 1b

The electronic media can also accompany the culinary food and related culinary products. The electronic media can provide the end user with immediate access to educational and informational guides, interactive video demonstrations and electronic links regarding the particular culinary food and related culinary products. The end user will also find information from the electronic media to direct the end user to the method and educational teaching system available on the manufacturer's or merchant's communication networks.

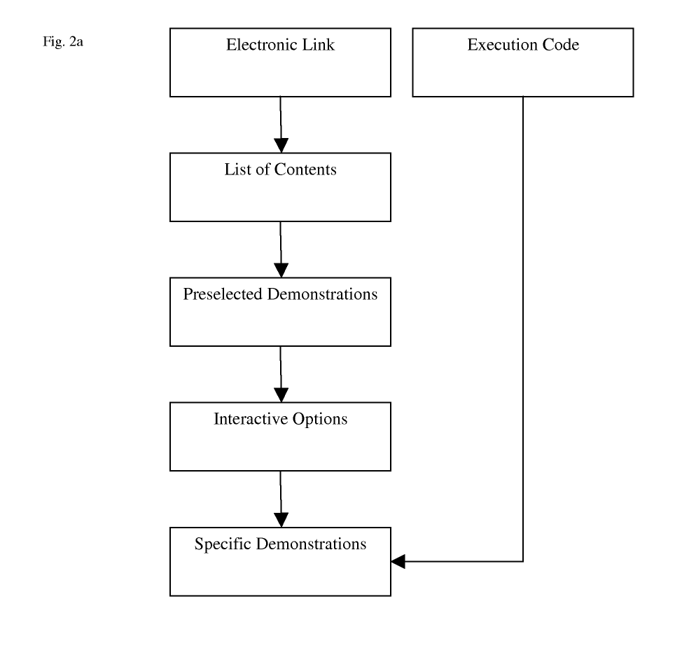

### FIG. 2

### FIG. 2a

Information, including a World Wide Web link and execution code, is provided on the hang tags or electronic media for the end user to access the method and educational teaching system regarding that particular culinary food and/or related culinary product. Each execution code corresponds with a particular product allowing the end user to gain access to a preselected video demonstration. End users will not have to shuffle through the general list of contents to access the preselected video demonstration regarding the particular product.

Without an execution code, general suggestions are available on the manufacturers' or merchants' website allowing the end user to browse popular suggestions preselected by the server system.

End users can access the culinary food and related culinary food products demonstration system via communication networks. The method and educational teaching system can be accessed at any location and time and in a variety of languages. The method and educational teaching system can be accessed globally via communication networks. No additional hardware is required, although it can be incorporated. Any electronic devices supporting the appropriate operating system can also be used.

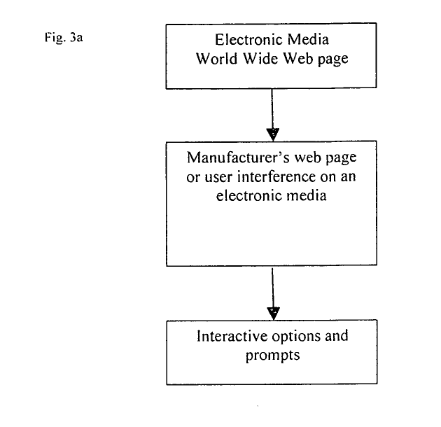

### FIG. 3

Upon visiting the World Wide Web page or accessing the information through the electronic media, the end user is welcomed by the manufacturers' or merchants' web page or a user interface with an assortment of interactive options. If the end user wishes to follow the preselected demonstrations and informational guides, the end user can select from a list of contents and allow the server system to generate a set of demonstrations for the end user to follow.

The welcome web page provides interactive options for the end user to select and/or choose interactive video demonstrations, recipes, etc. End users can select the option for interactive video demonstrations or enter the execution code telling the method and educational teaching system to pull up informational and educational demonstrations for the product of interest.

The end user can also follow prompts and provide the method and educational teaching system with personal and/or business information, preferences and requests. The data provided will be stored by the method and educational teaching system on a server system to analyze and cater the interactive options to the end user's interest. The method and educational teaching system generates for the end user additional information regarding the culinary food and related culinary products.

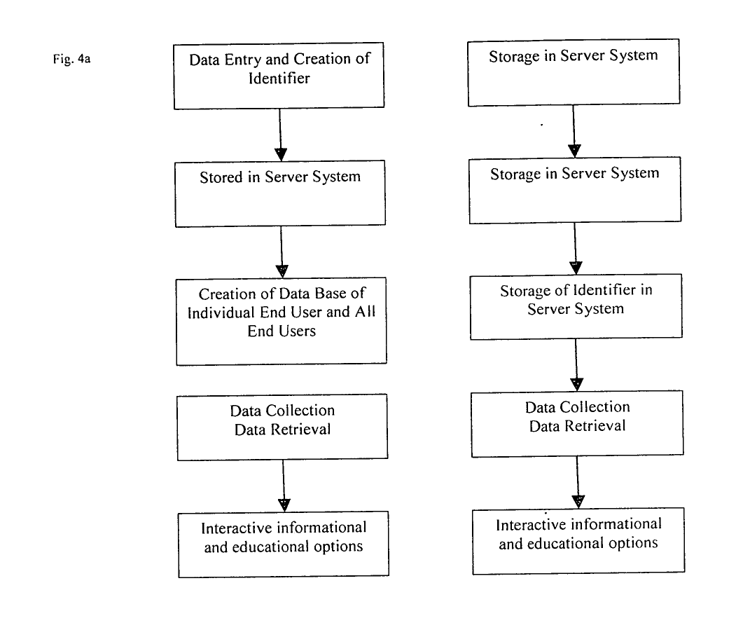

### FIG. 4

Each data inputted will allow the server system to build a data base of each individual end user, as well as a data base on all website traffic. Each data provides criteria for the server system to make suggestions for the end user. The more data inputted the more the server system can make suggestions to the end user based a logarithm calculation.

The stored data can be retrieved when the method and educational teaching system recognizes the same end user. The end user can create an identifier, such as a username and password, in which the method and educational teaching system will store on a server system. When the end user returns and is recognized, the method and educational teaching system will retrieve the stored information and reproduce the end user's information, preferences and requests in order to recreate the same interactive and customized culinary food and related culinary food products demonstrations.

The method and educational teaching system also provides interactive video demonstrations, recipes/nutritional facts, interactive demonstration options, purchase options, educational and informational facts and suggestions and questions and answer with the merchant or manufacturers. End users could learn about disclaimers and warranties as to allergies regarding the culinary food and related culinary products from the interactive video demonstrations, recipes/nutritional facts or by asking the merchant. End users can correspond with the merchant during a live informational discussion session, by e-mail, by posting comments or calling the merchant directly. Each of these options are made available directly on the web page and accessible through prompts or permanent icons on the web page.

The execution code provides the server system with direct instructions to retrieve particular product demonstrations. Without an execution code, the end user can select from general videos suggested by the server system. The general videos are suggested based on popular demands to draw end users to certain products. With each general video, the server system continues to provide interactive options to lead the end user to a customized video and learning scenario.

The execution code allows the end user to directly retrieve a particular product demonstration. Each production demonstration, general or customized, continues to provide the end user with interactive options to cater each demonstration to the end user's desires.

In addition to the personal/business information, preferences and requests initially inputted by the end user, each prompt selected by the end user continues to build the informational data base and allows the server system to make additional suggestions to the end user.

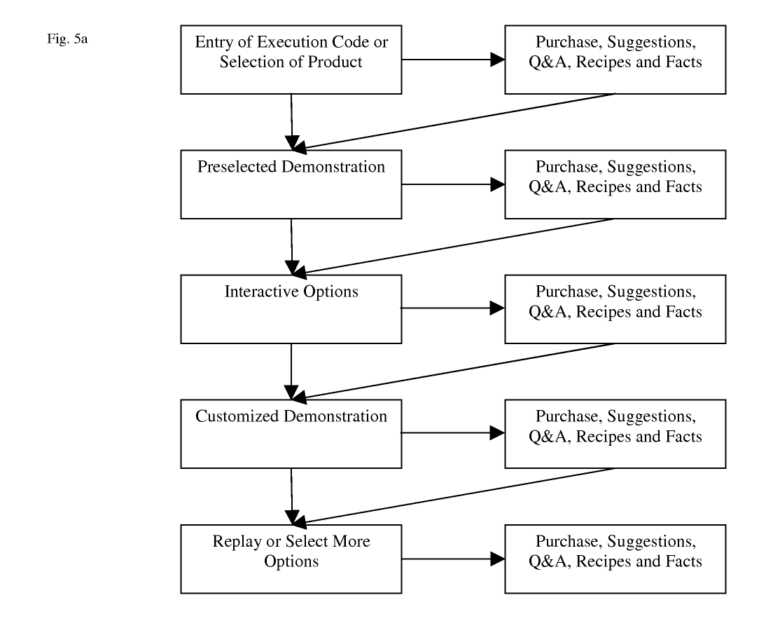

### FIG. 5

### FIG. 5a

Depending on the end user's product of interest and preference, the end user can participate in a general interactive video demonstration of the culinary food and related food product or cater the interactive video demonstration by selecting the available interactive options. The options are available by pop-ups, permanent icons or links on the manufacturers' and merchants' web page.

Each interactive option selected will produce a customized and interactive video demonstration, additional recipes/nutritional facts and purchase options. In addition, option for correspondence with the merchant is made available to the end user, including communication for follow-up questions. The interactive options are available before, during and after the server system makes its suggestions.

If the end user does not select any of the interactive option but selects a demonstration from the list of contents a general demonstration is generated. The general video demonstration explains to the end user the uses and recommendations of the culinary food and related culinary products, including easy to complex food preparations and instructions. The general video demonstration could also have interactive options to allow the end user to customize the general video demonstration.

Once the interactive video demonstrations initiates, the end user is provided with additional interactive options for the specific product to customize the interactive video demonstrations. Depending on the interactive options selected, the method and educational teaching system will reassess the end user's interest and suggest the best suited interactive video demonstration to the end user. For example, the end user can select the interactive option to see beef, chicken or vegetarian preparations. Or, for example, the end user can select the interactive option to see quick fix meals or gourmet dishes. Along with the interactive video demonstrations, the method and educational teaching system will also suggest recipes, other culinary food and related culinary products and upcoming events that best suit the end user.

If the end user does not make a selection from the interactive prompts, the server system will generate demonstrations, including video and recipes, based on preselected option by the host or by popular demands for a particular product.

Before, during or after the interactive video demonstrations, the end user can ask, answer or discuss the interactive video demonstrations in real time with an agent from the merchant or manufacturer in the correspondence with the merchant portion. If the end user has created an identifier, contact information of the end user can populate the correspondence inquire to allow the end user quick communication with the manufacturer or merchant.

Throughout the interactive video demonstrations, products can be made available for purchase. This includes the culinary food and related culinary products, as well as any kitchen items, used in the interactive video demonstrations. The options to purchase the items are made available as the items appear in the interactive video demonstration, at the end of the interactive video demonstrations or as a separate prompt. End users can select the option to purchase the product and place an order of that product. Or the end user can wait until the end of the video demonstration and see the entire list of products for purchase. A list of vendors corresponding with the particular product is also provided.

The end user can replay the interactive video demonstrations, select more interactive options to watch other interactive video demonstrations or end the interactive video demonstrations and resume at a later time. Each interactive video demonstration provides information and teaches the end user about the uses and recommendations of the product. In return, the end user can make comments and suggestions to the manufacturer and merchant regarding the product.

At any point the end user has the ability to continue with the interactive video demonstrations, select additional interactive options to retrieve additional suggestions, review recipes, ask questions, etc. After each selection, the end user has the ability to resume viewing the interactive video demonstrations, replay the interactive video demonstrations, etc. With the interactive options available, the end user can participate in multiple interactive video demonstrations.

What is claimed:

1. A method and educational teaching system to inform and educate end users, including consumers and vendors, of culinary food and related culinary products, comprising of:
Inputting into the server system end users' personal and/or business information, preference and requests;
Inputting into the server system the execution code for the particular culinary food or related culinary product;
Storage of end users' personal and/or business information, preference and requests in the server system; and
In response to the information, preference and/or requests provided, the method and educational teaching system will suggest available interactive video demonstrations, recipes/nutritional facts, product purchase options and additional informational and educational options.

2. The method of claim 1, in which the step of inputting information, preferences and requests into the server system comprises:
End users can create an identifier to be stored on the server system;
The end users' information, preferences and requests will be saved on the server system and automatically generated when the end user's identifier is recognized;
Based on the information, preferences and requests provided, the server system generates informational and educational culinary food and related culinary products demonstration to the end user via communication networks and electronic media;
End users can also provide payment information to the server system to utilize product purchase options;
The payment information can be saved along with the end user's information, preferences and requests and can be automatically generated when the end user's identifier is recognized;
End users can provide information by selecting available interactive options or by following the prompts, such as creating a log-in and password, requesting e-mail notifications or indicating desired products of interest; and
By selecting the available interactive options and/or by following the prompts, the method and educational teaching system suggests and provide additional prompts, options, video demonstrations, recipes/nutritional, product purchase options and educational and informational facts and suggestions relating to the culinary food and related culinary products.

3. The method of claim 1, in which the step of imputing an execution code, comprises:
The execution code is distributed via communication networks, product tags or electronic media; and
Without the execution code, the server system automatically generates popular video demonstrations options for the end user to select.

4. The method of claim 1, in which the step of storing personal/business information, preferences and requests, comprises:
The server system reviews the stored information periodically to generate suggests for end users.

5. The method of claim 1, in which the server system generates suggested video demonstrations, comprises:
Video demonstrations to inform and educate end users of a particular culinary food and related culinary product;
Video demonstrations of one or more culinary food and/or related culinary product;
Each video demonstration is followed by additional suggestions or prompts;
End users can select interactive options before, during or after the video demonstrations to retrieve additional interactive options; and
End users can participate in multiple video demonstrations at each end user's choice of time, location and language.

6. The method of claim 1, further comprising:
Based on each end user's input of personal and/or business information, preferences and requests, the server system makes suggestions of products for purchase;
Upon selecting an available interactive option, the end user is informed of the specifics of the product available for purchase, reviews and price;
End users can purchase particular items or browse through a catalogue for other items; and
Based on each end user's input of personal and/or business information, preferences and requests, the server system makes suggestions of other products, available for purchase through the available interactive prompts during the video demonstrations or through fixed icons.

7. The method of claim 1, further comprising:
Notifications to end users of product updates and calendar of events.

8. The method of claim 1, further comprising:
Storing payment information from end users;
Allowing end users to contact vendor or merchant directly; and
Transmitting payment from end users to the seller.

9. The generation of suggested videos, purchase options and other interactive options are based on a logarithm calculation based on each end user's input.
